(19) United States
(12) Patent Application Publication
(10) Pub. No.: US 2005/0131791 A1
(43) Pub. Date: Jun. 16, 2005

(54) Cost option based real options investment valuation

(76) Inventors: Ian C. MacMillan, Radnor, PA (US); Alexander B. Van Putten, Cochransville, PA (US)

Correspondence Address: CONNOLLY BOVE LODGE & HUTZ, LLP, P O BOX 2207, WILMINGTON, DE, 19899, US

(21) Appl. No.: 11/013,273

(22) Filed: Dec. 15, 2004

Related U.S. Application Data
(60) Provisional application No. 60/529,176, filed on Dec. 15, 2003.

(51) Int. Cl. G06F 17/60

(52) U.S. Cl. 705/35

(57) ABSTRACT

A method and system for determining investment value adds data representative of real options value of forecast revenues to data representative of net present value, and subtracts data representative of real options value of cost forecasts.

### CROSS-REFERENCE TO RELATED APPLICATIONS

This application claims benefit under 35 USC 119(e) of U.S. Provisional Application No. 60/529,176, filed Dec. 15, 2003.

### FIELD OF THE INVENTION

The present invention relates generally to financial analysis, and more particularly to methods of valuation using cost option based real option analysis.

### BACKGROUND OF THE INVENTION

As organizations face increases in competitive and market uncertainty, attention is being given to the use of real options analysis as a mechanism-of investment evaluation. The strategic challenge facing organizations is not so much that of predicting the future, but of adapting to and exploiting the inevitable uncertainty necessarily present in any future based scenario. It is generally true that the greater the uncertainty of a particular investment, the higher the expectation of increased reward. Yet when uncertainty is greatest, traditional analytical models can fail to provide adequate measure of value. Notably, the traditional discounted cash flow (DCF) approach, where typically a single expected present value is computed, breaks down and can fail to provide any meaningful measure of return when confronted with a high degree of uncertainty. This is so because the increased risk associated with uncertainty is reflected in an unduly high discount rate. But in addition to the downside risk reflected in the discount rate, uncertainty may very well present the reward of a high return, which is not accounted for in the DCF model. Thus, DCF can underestimate real options value or fail to account for it altogether.

A real option gives its owner the right, but not the obligation, to buy or sell an asset at a predetermined price for a period of time. In real options analysis, the idea is for an organization to consider the future as occurring in a certain manner, to identify the organization's optimal response to that occurrence, and to then determine what the organization would have to do at the present time in order to be in a position to effectuate that optimal response. By way of example, consider a real options scenario as might occur within the communications industry—an industry that requires large commitment of capital in the face of technological, market and regulatory uncertainty. The approach would begin by identifying market synergies—new lines of business that were viewed as potentially, though not necessarily, critical elements of future product market strategies. The communications company might have investments (i.e. real options) in local, long distance, wireless telephony, satellite television, television broadcasting, newspaper publishing, Internet portals, and Internet access. These assets could be acquired over an extended period of time and operated as autonomous strategic business units. By operating the divisions as independent units, the company is able to delay integration efforts until favorable outcomes are most likely. Alternatively, if an asset appears to lose appeal in terms of the company's product mix, it could be divested. Each new operating division, then, represents the right but not the obligation to make further investment in cross-divisional cooperation and integration. Real options provide a mechanism in which a company can prepare for the future without committing completely by integrating with the company's core business practice. Thus, real options afford the company an ability to maintain operational integrity yet at the same time position themselves to expand as the market evolves.

Real options are different from the typical financial options, which have a definite life, and must be exercised under predetermined conditions as described in U.S. Pat. No. 6,263,321. By contrast, real options can be held for as long as their strategic need warrants. Organizations must continuously monitor their operational environment to determine which options appear to be materializing and which appear to be waning as possibilities—so called “in-the-money” and “out-of-the-money” positions. Real options provide the ability to structure projects in stages, then abandon or expand the projects depending on future developments. Real options are valuable sources of corporate flexibility. And just as the price of a financial option in, for example, a security is but a fraction of the value of the stock upon which it is based, so too can the price of a real option be but a small percentage of the full value of a controlling interest in a resource in a market that is today but a mere possibility, i.e. uncertain. Real options can take any investment form, such as partnership, joint venture, partial equity stake or acquisition.

A significant portion of the value of real options lies in the flexibility they create. When an organization must confront an uncertain future without the benefit of a clearly articulated plan, but, rather, with a series of contingent or just-in-case strategies, success will lie in knowing when, and if, to exercise the real options. This way of thinking inspires a culture that can stimulate and sustain innovation because failure, in the sense that it is recognized and acted upon, is tolerated because terminating unsuccessful, “out-of-the-money” efforts is in actuality cost saving—failure is considered the price of a ticket to success. In fact, though seemingly paradoxical, for an innovative company using Real Options Reasoning (ROR) the velocity of failure will increase but the cost of such failures will decrease.

Despite the benefits of adopting a real options based approach to investment decision making, organizations considering real options have found a number of stumbling blocks in implementing a traditional real options methodology. Some stumbling blocks include: (1) a fear that a real options based approach encourages labeling every risky project as a real option undertaking; (2) a concern that people would be encouraged to label every project as a real option so that if it failed it would be regarded as an inevitable consequence of real options-like investing; (3) a concern that people employing a real options based approach will continually refine the numbers to distort the outcome until the project is completed; and (4) a concern that the cost of doing a full-fledged real options valuation is time-consuming, requires expensive talent and is hardly worth the effort and expense given the many investments that end up being rejected.

Accordingly, what is needed is real options based approach to investment decision making that is free of the stumbling blocks present in traditional real options based analysis.

### SUMMARY OF THE INVENTION

In a first embodiment, the invention involves a method for determining real option value which includes providing a first option value of forecasted revenues associated with said real option; providing a second option value of forecasted costs associated with said real option; and reducing said first option value by said second option value to form said real option value. The first option value of forecasted revenues associated with said real option and second option value of forecasted costs associated with said real option can each be determined using a variety of methodologies.

In a further embodiment, the invention involves a method of valuing an investment which comprises forming a net present value of forecasted investment cash flow; forming a net real option value of one or more real options comprising forecasted revenues and forecasted costs; and combining said net present value and said net real option value to form a value indicative of investment value.

In a further embodiment, the invention involves a method of determining total project value of an investment that comprises determining data representative of net present value; determining data representative of real option value of forecasted revenues of the investment; determining data representative of real option value of the forecasted costs of the investment; combining said data representative of real option value of forecasted revenues with said data representative of real option value of forecasted costs to determine net option value; and combining said net present value with said net option value to determine said total project value.

In a further embodiment, the invention involves a system for determining total project value of an investment, which system includes a device for receiving or determining data representative of net present value; means for forecasting revenue from the investment and determining a real option value of the forecast revenue; means for determining data representative of a real option value of an investment cost forecast; processing means for determining a total project value of the investment; and a memory device operatively connected to the processing means to at least store a plurality of data representations, wherein the total project value is determined at least in part by the processing means by adding the data representative of the real option value of the forecast revenue to the data representative of the net present value and subtracting data representative of the real option value of the investment cost forecast.

In a still further embodiment, the invention provides at least one computer-readable medium having a plurality of computer executable instructions for facilitating determination of total project value, the computer executable instructions comprising steps of determining data representative of net present value; determining data representative of real option value of forecasted revenues of the investment; determining data representative of real option value of the forecasted costs of the investment; and determining a value for total project value by adding data representative of real option value of forecasted revenues to said data representative of net present value and subtracting data representative of real option value of the forecasted costs.

A further embodiment of the invention involves a method of presenting a project comprising providing a standby having the capacity to expire; providing one or more milestones associated with said project that are capable of serving as a basis for exercising said standby; and exercising or not exercising said standby based on said one or more milestones.

A still further embodiment of the invention relates to a method of controlling the duration of an investment comprising providing a standby having the capacity to expire; providing a trigger value capable of serving as a basis for exercising said standby; and exercising or not exercising said standby based on said trigger value.

Aspects of the embodiments described above, their elements and/or means may be implemented in a computer or other data processor using appropriate software. Such software can result from modification of software available to those skilled in the art in order to implement the methods described herein.

### BRIEF DESCRIPTION OF THE DRAWINGS

FIG. 1 illustrates total project value as a function of uncertainty.

FIG. 2 illustrates a flow diagram where a real options valuation of an investment is formed using cost based real options valuation.

FIG. 3 illustrates a flow diagram where total project value is formed using cost based real options valuation.

FIG. 4 illustrates a flow diagram where total project value is formed using Abandonment Value.

FIG. 5 illustrates a flow diagram featuring a project management structure implementing a Standby.

FIG. 6 illustrates a flow diagram where a real options valuation of an investment is formed using a Standby.

FIG. 7 illustrates a flow diagram where total project value is formed using both Abandonment Value and a Standby.

### DETAILED DESCRIPTION

This invention relates to a method and system for using a cost option based real option in the valuation of an investment. In one embodiment, a cost option based real option is applied in the context of a project as a component of total project value. In connection with determining the individual values in the claimed methods one can use such traditional methodologies for assessing real options as: the decision-tree method, which uses discounted cash flow (DCF) valuation but weighs results by means of a decision tree; the binomial method, which is based on the assumption that two possibilities exist in each new decision phase; and the Black-Scholes method, which combines various important factors for option assessment. See Chapter 40, Guide to Finance For Lawyers, Ayers (Lexis 2001) entitled “The Black-Scholes Option Pricing Model (BSOPM)”. These methods are available to all embodiments and are known to those in the art. Additionally, the implementation of a cost option based real option process conducted in accordance with an aspect of the present invention is described herein as being carried out on a computer. A computer, however, is not essential to perform any of the steps of the invention. The methods and/or individual steps of the methods may be performed manually without machine aid, or through a combination that employs a logical system with human input. If a computer is used, however, software employed to carry out the process may be implemented in hardware or firmware, or stored on one or more computer-readable media. The computer readable medium may comprise memory storage that is volatile or non-volatile, and may comprise one or more components.

Uncertainty, which by its very nature holds the potential for both good and bad outcomes, increases the value of options because there is the possibility of achieving a large upside gain while the only downside exposure is the cost of the real option itself. Following this logic further, the value of a real option must then increase as the volatility, i.e. the uncertainty, of the underlying asset increases, whether that asset is financial or “real.”

Effective implementation of real options requires a fundamental shift in the way performance of operating management is determined. Given the high degree of uncertainty in which real options are deployed, it is inevitable that some options will be “out-of-the-money” and require termination. Unfortunately, operating managers may view such premature project termination as failure and therefore be reluctant to walk away from an unhealthy option. From a real options perspective, dropping an “out-of-the-money” option is, in fact, no failure at all but simply a recognition that the optimal circumstances under which that particular real option was meant to anticipate—the right it meant to preserve—never materialized.

Balancing the need for operating managers to commit to project implementation with the inevitability of having to terminate “out-of-the-money” real options without undermining the performance measures of those involved requires a deep level of involvement from executives. Strategy ceases to be about commitments and instead is about identifying contingencies. Effective management is, then, characterized by appropriate response to new information as it is acquired, which could dictate expanding, suspending or abandoning a project. The key to real options thinking in accordance with the present invention is that risky investments are not only acceptable, they are desirable as long as the cost of failure is limited.

### An Expanded Definition of NPV

To avoid the stumbling blocks associated with the traditional real options approach, an expanded notion of value is employed in this invention to arrive at a result termed Total Project Value (TPV) in the context of a project. Traditional DCF analysis results in a net present value (NPV) calculation that relies on the decision rule that an investment with a positive NPV should be funded because the investment creates value above its costs. This approach works well enough if cash flow is projected from a historical context and future trends are fairly certain. When confronted with the uncertainties of a new product development, however, NPV analysis can lead to poor decisions. The first difficulty encountered is that future cash flows are difficult to ascertain because the data upon which cash flow is based is premised on a myriad of assumptions. Secondly, defining a discount rate that properly reflects all the risks found in an innovative project is difficult to arrive at with any degree of accuracy. If the discount rate is inaccurate, the resulting analysis may overstate, or understate, the present value of cash flow. This may lead to inadvertent funding of losing investments if the discount rate is too low, or abandonment of potential winning investments if the rate is too high. But uncertainty, which is the bane of meaningful NPV calculations, is the primary driver of real options valuation due to the asymmetric nature of an option's payoff. Consequently, real options analysis values uncertainty in a positive context, which means that high levels of uncertainty lead to high real options value—holding other factors constant. This leads to the conclusion that the value of highly uncertain projects can be represented by two components: NPV and net real options value, NOV.

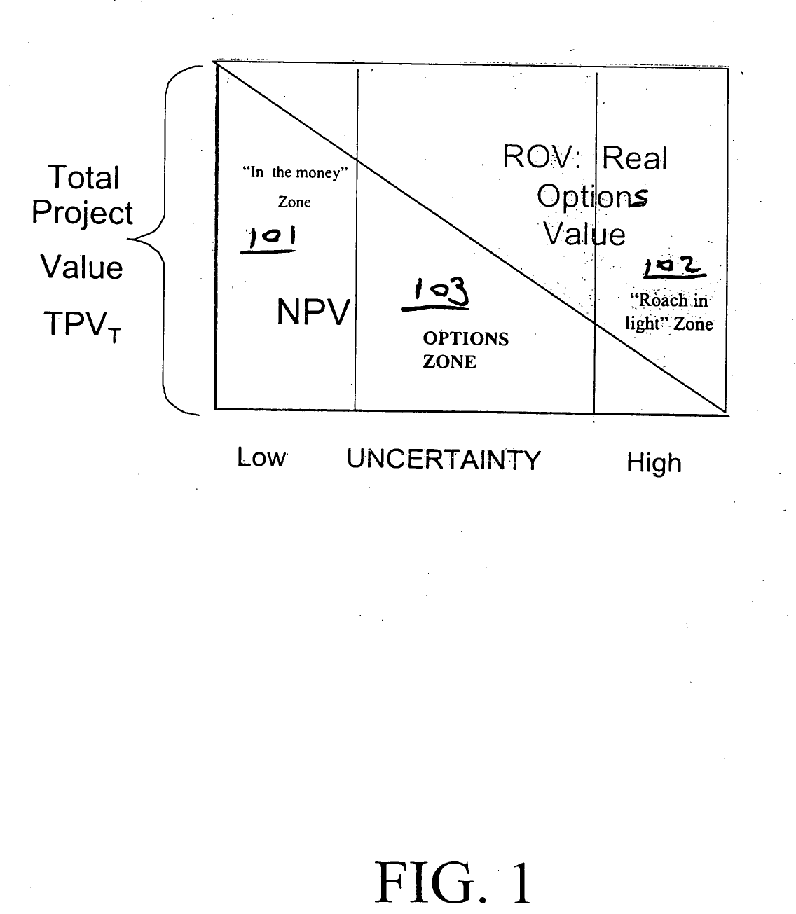

At the onset of an innovative project, the project will have little NPV because of the need to use a high discount rate to adjust for the uncertain nature of future cash flows. At the same time the real options value of the project will most likely be high due to that same uncertainty. FIG. 1 shows the relationship between NPV and real options value as a function of uncertainty. In the lower left corner of the chart uncertainty is low, so the project value as measured on the vertical axis is composed primarily of NPV with very little real options value, if any. This is the so-called “in-the-money” zone 101. As uncertainty increases, project value becomes more and more reliant on real options valuation because NPV analysis heavily penalizes value through use of higher discount rates. Thus, in the far right corner of the chart uncertainty is highest and project value as measured on the vertical axis is primarily composed of real options value with very little NPV, if any. This is the so-called “roach-in-the-light” zone 102 because at this level of uncertainty most investors are running.

As project development unfolds and more is learned, project outcome will become more accurately defined because facts and knowledge replace assumptions (whether favorable or unfavorable to an initial view), which in turn reduces uncertainty. Thus, a project's NPV and real options value will be changing as knowledge replaces uncertainty. NPV will increase if the forecast of future cash flow remains the same or rises because a lower discount rate is warranted due to the reduction in risk. Conversely, NPV could decrease if future cash flow appears to be less appealing than originally projected or should the project become riskier, which would call for application of a higher discount rate. At the same time, the combination of a reduction in project uncertainty and the approach of real options expiration will decrease the value of project real options. On the other hand, if what is learned during development increases the uncertainty surrounding the project outcome, then the real options value could increase due to increased volatility. Such an increase could overcome the degradation in real options value associated with expiration. Further, were the development period to be extended then the real options value of the project would increase. Thus, valuation of uncertain projects is not static as implied with traditional NPV analysis, but is dynamic and changes with learning. Accordingly, FIG. 1 does not suggest that project value remains static, but rather that valuation components change in relation to uncertainty. The equation to capture this expanded valuation begins with the following:
TPV=NPV+ROV (Equation 1)
Where:
TPV =total project value, or, the expanded value of NPV including the real option value of the asset;
NPV =net present value of the investment;
ROV =real option value of the investment.

Equation 1 suggests that project value can be viewed as a continuum composed of shifting NPV and real option values—values that shift up or down in accordance with the future prospects of the project. This equation is the foundation upon which managers can begin a real options based analysis in accordance with the invention. Another insight gained from Equation 1 is that if the NPV of a project is either very positive or very negative there is little reason to compute the real options value since the real options value is eclipsed by NPV. If NPV is very large, the decision should be to proceed with haste. Similarly, if NPV is very negative the project should be abandoned. It is when the NPV is modestly positive or somewhat negative that difficult decisions must be made. This region of moderate NPV values is referred to as the Options Zone 103. It is within the Options Zone that managers desire an expanded definition of value because traditional DCF metrics fail to provide guidance. Rather than falling back on intuition or heuristic techniques, evaluating the real options value (ROV) of a project can provide a quantitative approach to assessing the total value of a project.

### The Real Options Value Of Costs

Equation 1 presents potential to overstate the real options value of a project because ROV increases with volatility regardless of the source of that volatility. In one embodiment of the disclosure the real options value of an investment includes adjustment for the real options value of costs. The volatility of an investment is composed of uncertainty associated with projected revenues and uncertainty associated with costs. The volatility of costs, especially if higher than that of revenues, should not increase the value of a real option on an uncertain investment, but should instead reduce the real options value. The real options value of costs is a construct that can be computed from the range of values used in building the forecast of expected future cash flows. The greater the uncertainty surrounding an investment, the wider the range of values that form the forecast for that investment, which in turn leads to greater volatility estimates and higher real options value. For example, suppose that it can be determined with a high degree of certainty that the selling price of a widget will be between $12 and $14 next year. The $2 range in the expected selling price will flow through the financial model and lead to an implied volatility that drives real options value. But suppose the selling price has a higher degree of uncertainty with an estimated range of $10 to $18. The larger $8 range in the expected selling price will increase the real options value because the uncertainty surrounding the future profitability of the widget is increased. But suppose the revenues of a project are fairly certain but not the costs. This could happen when planning the ‘slam dunk’ product that everyone would want if only it could be produced at a reasonable price. Or consider the uncertain development costs in biotechnology. Under traditional real options valuation methods, uncertainty has the effect of increasing the volatility of projected returns, and therefore real options value, without regard to whether the uncertainty lies with costs or revenues. But a venture with undefined development and/or operational costs is not necessarily more valuable than one that has a more certain cost structure. Highly uncertain cost structures create real risks of investment losses that should not be mitigated by the high real options value they can engender.

For example, a new compound may have huge potential as an additive for consumer products and large sums may have been spent on consumer testing and product development. All of this work showed a huge potential, assuming a production cost about $20. But insufficient effort was spent on developing a cost efficient process to make the product and that cost could not be achieved. Had the company managers taken into account cost volatility, they would have calculated a much smaller total project value which would have led them to curtail investment in the project at an earlier stage saving it millions of dollars. Accordingly, one embodiment of the disclosure presents the real options value of an investment as comprising the real options value of investment costs.

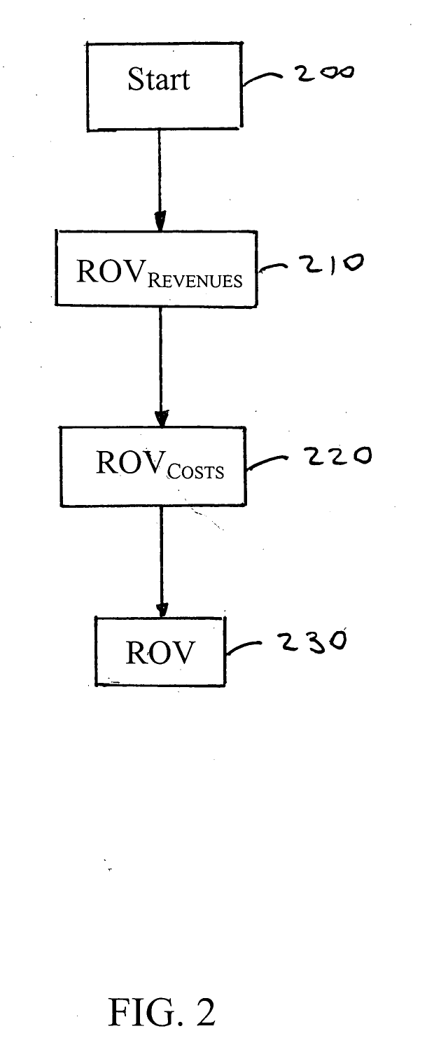

FIG. 2 illustrates a flow diagram presenting steps performed in forming an investment valuation comprising a real options value that accounts for the real options value of costs. Following Start 200, the real options value of the forecasted revenues of the investment, ROV_{REVENUES} 210, is provided. ROV_{REVENUES} 210 can be determined using any valuation methodology useful in figuring the value of real options. Such methodologies include, but are not limited to, decision tree analysis, binomial method, and the Black-Scholes method. ROV_{REVENUES} 210 can be determined by the individual or entity conducting the investment valuation or it may be supplied, as might occur when another entity or source is consulted. Entity, as used within this disclosure, is any source capable of directing the investment valuation and may include individuals, organizations, computer programs, etc.

Another step is to provide the real options value of the forecasted costs of the investment, ROV_{COSTS} 220. Forecasted costs include, but are not limited to, development costs, cost of goods sold, fixed and variable costs relating to the investment under consideration, etc. ROV_{COSTS} 220 can be determined using any valuation methodology useful in figuring the value of real options. Such methodologies include, but are not limited to, decision tree analysis, binomial method, and the Black-Scholes method. ROV_{COSTS} 220 can be determined by the individual or entity conducting the investment valuation or it may be supplied, as might occur when another entity or source is consulted. ROV_{COSTS} 220 is then combined with ROV_{REVENUES} 210 to form a total real options value, ROV 230—the real options measure for the investment valuation.

It is contemplated that the steps taken in accordance with this disclosure can be performed in a sequence resembling that described but this is not essential to arriving at the real options value, ROV 230. Thus, ROV_{COSTS} 220 may be provided before ROV_{REVENUES} 210 and vice versa. ROV 230, then, is formed by combining ROV_{COSTS} 220 and ROV_{REVENUES} 210 regardless of the order in which they were obtained. Additionally, the formulation of ROV_{REVENUES}210, ROV_{COSTS} 220, and ROV 230 may be determined via a computer using software configured to evaluate real options.

Because real options value (ROV), as presented within this disclosure, is a combination of the real options value of forecasted costs and the real options value of forecasted revenues, it can be referred to as a net real options value (herein “NOV”). This terminology is useful when discussing real options in conjunction with traditional valuation methodologies, such as net present value (NPV).

Equation I expresses the insight that project value is a continuum of shifting NPV and ROV. In one embodiment of the invention, ROV is presented as the real options value of forecasted revenues less the real options value of forecasted costs, i.e. net real options value. Thus, Equation 1 expands to:

$$\begin{matrix}TPV = NPV + ( {ROV}_{REVENUES} - {ROV}_{COSTS} ) \\ = NPV + NOV\end{matrix} \qquad ( Equation 2 )$$

Where:
TPV=Total Project Value (See Equation 1)
NPV=Net Present Value of the investment
ROV_{REVENUES}=the real option value of forecasted revenues of the investment;
ROV_{COSTS}=the real option value of the forecasted costs of the investment (costs include development costs, cost of goods sold, fixed and variable costs relating to the investment under consideration, etc.);
NOV=net real options value.

Equation 2 holds the insight that if the real options value of costs outweigh that of revenues, then the real options value of a project could be negative and therefore reduce the total project value. This condition arises when there is a great deal of uncertainty about the costs of a project, which would lead to a higher implied volatility of costs. The uncertain costs can therefore counter the effect of NPV. This illustrates a shortcoming in adapting financial option valuation methods to real options valuation; i.e., financial options cannot go below zero whereas real options can. In the financial world, the only loss that an options investor is exposed to is the cost of the financial option. But real world project losses can continue well beyond project launch. By separately valuing the option value of the cost structure of a project, which includes development costs as well as ongoing production costs, the real options value of a highly uncertain cost structure will decrease the total value of the project. Traditional real options valuation does not account for the real options value of costs, thus the uncertainty over the gross margin of a new product increases the option value of the project through the implied volatility of the cost structure. The importance of the real options value of costs, ROV_{COSTS}, is especially relevant in the Option Zone when managers face the toughest decisions about new investments.

ROV_{COSTS} can be determined, for example, by calculating the “call value” of development expenses and projected ongoing operating costs of a project were the project to be launched and completed—similar to the calculation of the call value of the projected revenues. This is similar to calculating the call value of costs avoided by not undertaking the project. This is accomplished by identifying a range of values for each cost assumption or forecasted cost made for the project. The range estimates should be wide enough so that there is a 90% certainty that all possible values for each cost element have been captured. For instance, the estimate of the cost of raw materials for a widget could fall within a range of $2.75 to $4.10 per widget with a 90% confidence that the actual cost will lay within that range. The high and low values of the range, and all of the intermediate values as well, flow through the financial model using easy-to-use simulation software that produces a distribution of all the possible costs of the project. This cost distribution yields a standard deviation which serves as the proxy for the implied volatility of costs that is the basis for calculating ROV_{COSTS}. While the concept of calculating the call value of costs is unique, and may not fit with traditional financial thinking, it is nonetheless valid within the realm of TPV and finds usefulness in guiding strategic decisions.

By way of example, consider the experience of a fictitious company called India Company. India Company was a company that intended to deliver global satellite based phone service to executives traveling internationally. India Company set the cost of their phones at $3,000 with access charges of approximately $8 per minute. Calls could only be placed outdoors and within the line of sight of India Company's satellites circling the equator. Not only was the business plan uncertain from the outset, but it also possessed a $5 billion cost structure! Using traditional real options pricing models, the uncertainties in the India Company business plan along with the cost structure would have generated enormous real options value. It is speculative to consider what India Company's management must have projected the future cash flow of the company to be in order to justify the $5 billion dollar investment, to contemplate the value of an option on that potential success, but this would belie the fact that billions needed to be spent before going to market. In accordance with an embodiment of this disclosure, the real options value of those tremendous costs would have reduced the TPV of India Company, leading to a greatly reduced valuation and perhaps an early rejection of the investment, rather than the subsequent liquidation of the company where the assets were sold for less than $70 million. Assuming that the $5 billion of costs were spent in one year, and assuming an alternative investment rate of 10%, then the discounted cost of India Company would be $4.54 billion. Further, because India Company required launch of numerous satellites, there was a great deal of uncertainty regarding the final costs of the project, thus yielding a volatility estimate of 40%. To obtain a sense of how an uncertain cost structure can impact project value, consider how India Company's costs could unfold over the year. Using the present value of expected costs of $4.524 billion as a starting point, project costs could unfold with a 40% volatility estimate to lie in a range of $3.04 billion (if all costs are at the low end of expected values) to $6.77 billion (if all costs are at the high end of expected values). Obviously this enormous range would have immense implications for the future profitability of the India Company venture. But to really understand what the uncertain cost structure means to the venture, we need to compute ROV_{COSTS}, which can be accomplished using techniques such as the Black-Scholes option pricing model. This yields a ROV_{COSTS} value of approximately $921 million, which management can then deduct from their calculation of India Company's projected value based on forecasted revenues. Given the large value of ROV_{COSTS}, however, India Company's management may have been deterred from proceeding with the project in the first place.

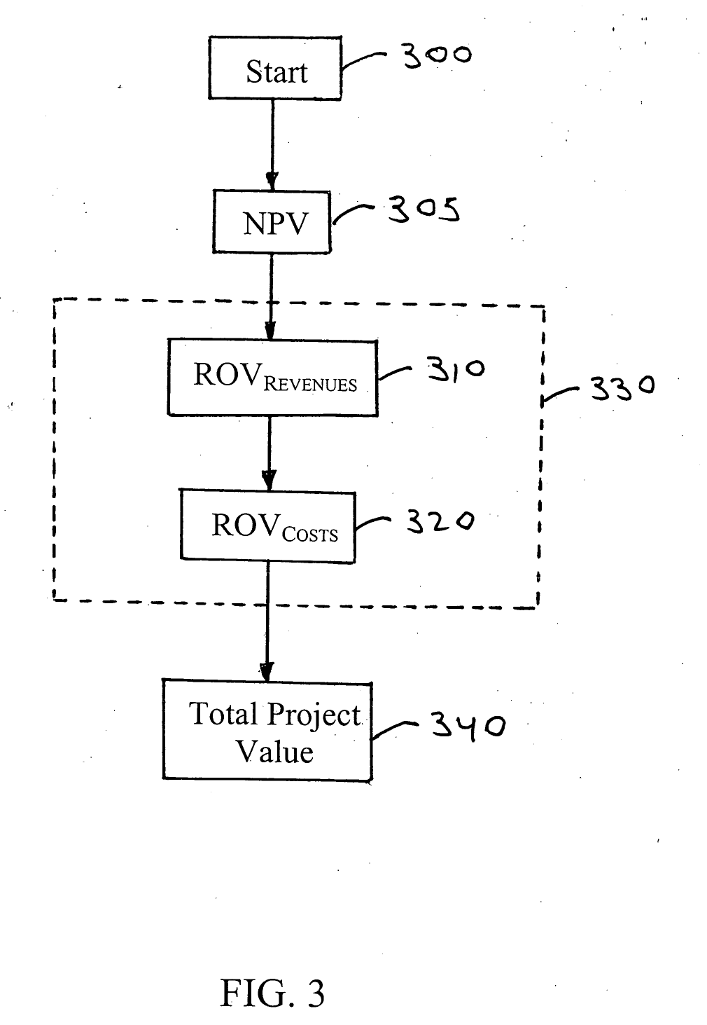

FIG. 3 illustrates a flow diagram where total project value is formed using cost-based real options. Following Start 300, the net present value of forecasted cash flow, NPV 305, is provided. NPV 305 may be determined by the individual or entity conducting the valuation or it may be supplied, as when another entity or source is consulted. The discount rate applied to NPV 305 may be formed using any traditional methodology and typically will be impacted by influences such as inflation, generalized and particularized risks, uncertainty, loss of liquidity, etc.

Another step is to provide the real options value of forecasted revenues for the project, ROV_{REVENUES} 310. ROV_{REVENUES} 310 can be determined using any valuation methodology useful in figuring the value of real options. Such methodologies include, but are not limited to, decision tree analysis, binomial method, and the Black-Scholes method. ROV_{REVENUES} 310 can be determined by the individual or entity conducting the investment valuation or it may be supplied, as might occur when another entity or source is consulted.

Another step is to provide the real options value of forecasted costs for the project, ROV_{COSTS} 320. Forecasted costs include, but are not limited to, development costs, cost of goods sold, fixed and variable costs relating to the investment under consideration, etc. ROV_{COSTS} 320 can be determined using any valuation methodology useful in figuring the value of real options. Such methodologies include, but are not limited to, decision tree analysis, binomial method, and the Black-Scholes method. ROV_{COSTS} 320 can be determined by the individual or entity conducting the investment valuation or it may be supplied, as might occur when another entity or source is consulted. ROV_{COSTS} 320 is combined with ROV_{REVENUES} 310 to form net option value, NOV 330. NOV 330 is combined with NPV 305 to form Total Project Value 340.

It is contemplated that the steps taken in accordance with this disclosure can be performed in a sequence resembling that described but this is not essential to arriving at Total Project Value 340. Thus, ROV_{COSTS} 320 may be provided before ROV_{REVENUES} 310 and vise versa. Further, either ROV_{COSTS} 320 or ROV_{REVENUES} 310 or both may be provided before NPV 305 or after NPV 305. Additionally, ROV_{COSTS} 320 and ROV_{REVENUES} 310 need not be combined in a separate step to form NOV 330, but may be combined individually with NPV 305 to form Total Project Value 340. In that instance, ROV_{COSTS} 320 will directly reduce Total Project Value 340 and ROV_{REVENUES} 310 will directly increase Total Project Value 340. Total Project Value 340, then, is formed by combining NPV 305, ROV_{COSTS} 320, and ROV_{REVENUES} 310 regardless of the order in which they are obtained. Additionally, the formulation of NPV 305, ROV_{REVENUES} 310, ROV_{COSTS} 320, and Total Project Value 340 may be determined via a computer using software configured to evaluate real options.

### Abandonment Value

Another embodiment of the invention is directed to incorporation of abandonment value within the cost-based real options assessment. There is strategic relevance to deducting ROV_{COSTS} from project value. Consideration of ROV_{COSTS} forces managers to focus on reducing the uncertainty surrounding the costs of a new project in order to increase TPV. Uncertainties surrounding costs are, at times, easy to determine because they are to some extent defined by the managers involved with a project. Thus, if senior management were to set a goal that a project must have a TPV of X at some future time in order to justify a second round of investment support, the easiest way for line managers to meet that goal is to tightly define the costs of the project. This focus serves the company well by preventing sunk costs from building up in advance of supporting data. This is a key skill to creating an innovative culture that embraces the notion that success is built on the back of many failures, provided the cost of failure is kept within determinable bounds and is recognized early so that resources can be redirected elsewhere. Thinking about the cost variance of a project should influence managers to look for ways to mitigate cost uncertainty by devising exit strategies in advance of investment. Pre-planned exit strategies create abandonment value that functions in the same way as a put option in the financial world—a hedge against lower future values. The idea is to devise ways in advance of making an investment in a project to create salvage value should the project be abandoned at some later time. Such abandonment value reduces the uncertainty of the project's cost structure and is therefore deducted from ROV_{COSTS}. This insight expands Equation 2 to become the following:
TPV=NPV+ROV_{REVENUES}−(ROV_{COSTS}−abandonment value) (Equation 3)

Equation 3 expresses the insight that as abandonment value increases, the value of ROV_{COSTS} decreases, which in turn increases TPV, holding NPV and the real options value of revenues constant. This motivates managers who are championing investments with uncertain outcomes to lock in abandonment value as an effective way to raise the value of TPV. This is a key skill for innovative companies.

Abandonment value can be created in a number of ways. First, consider the value that early investments in a project may have to another business unit internal to the company or to an outside entity. In large multinational corporations, projects that are not viable for one division may prove to be a departure point for another division elsewhere in the organization. Abandonment value can be created through internal transfer payments between business units, which establishes a price for development work accomplished before project termination. Alternatively, project assets such as Intellectual Property (IP) can be sold for cash or equity to other companies. For example, consider the case of a hypothetical pharmaceutical company that developed an experimental antibiotic research program. The experimental program showed promise in the treatment of drug resistant staphylococcal infections, but was unlikely to generate the sort of blockbuster drugs that were required to support the company's growth rate. Rather than merely relegating the IP of this company to a library of interesting compounds, abandonment value was created by trading the patents, technology, and marketing rights to develop this antibiotic for equity in a privately held bio-tech company. While at the onset of the project the company may not have foreseen this eventuality, the mindset that abandonment value must be created early in a project focuses managers on cost containment.

Creating abandonment value is especially important in businesses that operate with large fixed costs. In the previous example of India Company, perhaps management could not have avoided the huge sunk costs of launching a system of satellites before knowing how the market would evolve. Had India Company's management been focused on reducing ROV_{COSTS}, however, the management might have: a) seen that the business model was fundamentally flawed because the ROV_{COSTS} value was enormous; or b) deployed satellites that provided functionality beyond India Company's proprietary needs and thus be marketable to a communications industry hungry for satellite bandwidth—i.e. create abandonment value.

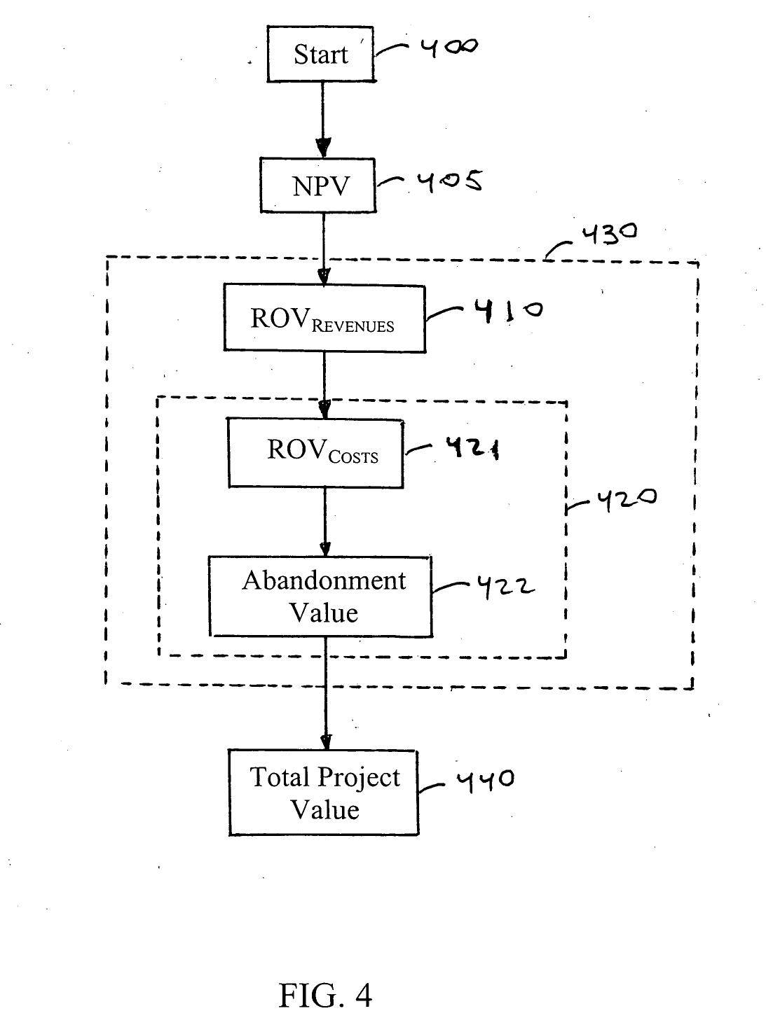

FIG. 4 illustrates a flow diagram where total project value is formed using cost-based real options including abandonment value. Following Start 400, values for NPV 405 and ROV_{REVENUES} 410 are provided. NPV 405 and ROV_{REVENUES} 410 are provided for in the same manner as the steps of providing NPV 305 and ROV_{REVENUES} 310 in FIG. 3, respectively. ROV_{COSTS}, however, is comprised of two sub-components: providing ROV_{COSTS} 421 and providing Abandonment Value 422. Thus, the total real options value of costs is a net value and can be identified as Net ROV_{COSTS} 420.

The step of providing ROV_{COSTS} 421 is provided for in the same manner as the step of providing ROV_{COSTS} 320 in FIG. 3. In another step, Abandonment Value 422 is provided. Abandonment Value 422 is combined with ROV_{COSTS} 421 to form Net ROV_{COSTS} 420. Net ROV_{COSTS} 420 is combined with ROV_{REVENUES} 410 to form Net Option Value (NOV) 430. NOV 430 is combined with NPV 405 to form Total Project Value 440.

It is contemplated that the foregoing steps will be performed in a sequence resembling that described but this is not essential to arriving at Total Project Value 440. Thus, Net ROV_{COSTS} 420 may be provided before ROV_{REVENUES} 410 and vice versa. NOV 430, then, is formed by combining Net ROV_{COSTS} 420 with ROV_{REVENUES} 410 regardless of the order in which they were obtained. Further, ROV_{COSTS} 421 and Abandonment Value 422 need not be combined to form Net ROV_{COSTS} 420 in a separate step, but may each be combined individually with ROV_{REVENUES} 410. Additionally, ROV_{COSTS} 421 and Abandonment Value 422 need not be combined with ROV_{REVENUES} 410 in a separate step to form NOV 430, but may be combined individually with NPV 405 to form Total Project Value 440. Note that if ROV_{COSTS} 421 and Abandonment Value 422 are to combine separately in arriving at Total Project Value 440, the negative operator will carry through Equation 3 so that ROV_{COSTS} 421 will reduce Total Project Value 440 and Abandonment Value 422 will increase Total Project Value 440.

Abandonment Value 422 may be provided at any time during the process illustrated in FIG. 4. In absence of Abandonment Value 422, the process illustrated in FIG. 4 reduces to the process illustrated in FIG. 3 until such a time as Abandonment Value 422 is provided. NPV 405, ROV_{REVENUES} 410, ROV_{COSTS} 421 and Abandonment Value 422 may be determined via computer using software configured to evaluate real options and net present value.

### The Standby

Another embodiment of the invention is directed to incorporation of a management standby within the cost-based real options assessment. The insights underlying Equation 3 help senior management solve the vexing problem of motivating line managers to abandon unpromising projects prior to full investment. Since increasing abandonment value directly increases TPV, senior management is in a position to at once stimulate innovation and control costs by providing line managers with a put option—the Standby agreement. The Standby provides financial incentive to managers who abandon failing projects before project funding is exhausted. The Standby can be structured in a variety of ways to meet individual company needs and to motivate management behavior. The CFO, or authorized individual, can offer a Standby agreement to project management in order to provide a sanctioned way out of disappointing projects. For example, consider a business unit that has been granted a $50 million allocation for a new project, and after having spent $10 million the business unit finds the project's future prospects to be less than hoped for. Without incentive, management may nonetheless proceed with the project because the business unit itself may still benefit from execution of the project even if overall the project falls short of corporate performance measures. To address this problem, companies can adopt various financial measures that can penalize managers for pursuing this sort of dilutive investment. But such measures are ineffective for two reasons: first, the measures are reactive in that they come into play only after allocated funding has been exhausted; second, they foster a lose-lose management style. The unsuccessful manager “loses” at his or her performance review, and the company “loses” in that resources have been squandered on a dilutive investment. With a Standby in effect, managers are encouraged to promptly terminate projects that are detrimental to overall company health. Though completion of the project may be beneficial to the manager on an individual or subdivision level, the Standby operates to compensate the manager for this loss so that a greater good for the company can be secured. In so doing, managers are disciplined to take the risks needed to push a company from a comfort zone into new growth areas.

The concept of Standby expands Equation 3 to become:
TPV=NPV+ROV_{REVENUES}−(ROV_{COSTS}−abandonment value−Standby) (Equation 4).

Equation 4 expresses the insight that TPV will increase with the addition of a Standby because the Standby operates to increase abandonment value of a project. An increase in abandonment value, in turn, decreases ROV_{COSTS}. A manager seeking funds for a new project will compete for funding with other investment alternatives by maximizing the TPV of their project. One way to increase TPV is to decrease the value of ROV_{COSTS}, which a Standby can accomplish.

The Standby is applicable to both traditional and real options based investment analysis. The Standby is a real option in the sense that it provides the right but not the obligation to be exercised in exchange for termination of a project. Thus, the Standby is a special class of real option and can be referred to as a “Standby option.” Like any real option, the Standby has its maximum life and value at the beginning of a project when uncertainty is typically highest. As uncertainty and life of any real options are reduced, the Standby will lose value rapidly. Thus, the Standby motivates managers to recognize failure early and limit losses to the company. The motivation arises because the business unit responsible for the project receives credit for the remaining value of the Standby. This credit helps to offset the loss of revenue the cancelled project may have generated for the business unit had the project been completed. The longer the business unit waits to exercise the Standby, however, the less value the Standby will provide because the Standby decays rapidly with time. Such motivation keeps managers highly focused on working fast to either prove or disprove their project hypothesis. The Standby also creates a safety zone that encourages managers to take risks because the Standby provides a sanctioned way to abandon disappointing projects. It is possible for unscrupulous managers to take advantage of the Standby by selling their company on a project and then exercising the Standby early so as to receive the value of the Standby option on their books. Such an ethical breech could happen once or twice in a well-run company, but thereafter the CFO would certainly identify the practice. To thwart such abuse, the CFO can charge a premium for use of a Standby on future projects, or the offending business unit could be denied Standby coverage altogether. The potential for gaming under the Standby methodology does exist, but this potential is no worse than the gaming that occurs with the use of DCF or any analytical model used to make investment decisions. Regardless of the potential for abuse, the Standby reinforces real option thinking by developing a key skill that innovative companies must have: the cultural ability to abandon disappointing projects early so that resources can be redirected elsewhere.

As an alternative to a Standby of finite duration, a renewable Standby can be provided. A renewable Standby could be applicable if project conditions change in a manner that might influence the value or duration of the Standby.

Returning to the example of a hypothetical $50 million project, at the beginning of the project the CFO could sell the business unit a Standby having a value of $25 million and the Standby could be indexed to various milestones associated with the project. The Standby would decay rapidly in accordance with predetermined milestones. For instance, after $10 million has been spent producing a prototype the Standby might be reduced to a value of $20 million. Should the prospects for the project seem disappointing at this juncture, the business unit could elect to exercise the Standby and receive a transfer payment of $20 million in return for release of the remaining $40 million back to the CFO. The company could then redeploy the funds to a more promising endeavor elsewhere in the company. Should the project progress and additional funds be expended, the value of the Standby would decline. The decline would occur at increasing rates in order to encourage early abandonment of the failing project. Thus, at the next milestone, the Standby may be worth $15 million to the business unit. Under such a program the business unit is motivated to provide an early alert to the CFO of a non-performing or sub-par investment in order to avoid diluting company resources. Because both the company and the business unit benefit by exercise of the Standby, the Standby is a win-win device.

The Standby provides additional benefits as well, such as motivating managers to reach beyond their comfort zone into new areas that may present future high growth for the company because the Standby mitigates the cost of failure to the business unit. Second, the Standby encourages new projects and ventures by keeping the cost of failure low because early abandonment is encouraged. Third, the Standby provides an objective view of executive performance without being stifling in that an executive who undertakes and completes poorly performing projects without exercise of a Standby may need to be questioned. Lastly, the Standby methodology effectively separates bad decisions from bad outcomes, which is essential to creating an innovative company culture.

Though Standby has been described relative to the internal operations of an organization, Standby can also be applied to an entity external to the company. Such a situation could arise when a contractor is utilized to perform a project. Though the motivation of a contractor to prematurely terminate a project to save funds of the company sponsoring the project might be suspect, in fact a contractor would be motivated to exercise the Standby in order to maintain good relations with the company. In establishing such goodwill, the contractor can become a preferred resource of the contracting company and thereby enjoy a long, fruitful relationship.

It is worth noting that a Standby is distinct from the traditional termination for convenience clause that might be found in a typical performance agreement. A termination for convenience clause is a hedge against the possibility that a project cannot be completed due to some unforeseen occurrence. It enables the company sponsoring the project to sever the agreement with the entity performing the project and liquidate financial exposure according to a mutually agreeable formula. The right to invoke the termination for convenience clause is at the company's sole discretion and there is no need to demonstrate fault. Thus, the termination for convenience clause is a top-down device. In contrast, a Standby is exercised by the entity performing the project, such as a business unit or contractor, and provides compensation reward indexed to timely project termination. Because operations managers and other individuals on the front lines of project management are often the first to identify project problems, the Standby provides motivation to these individuals to promptly take action. Thus, a Standby is a bottom-up device as opposed to top-down.

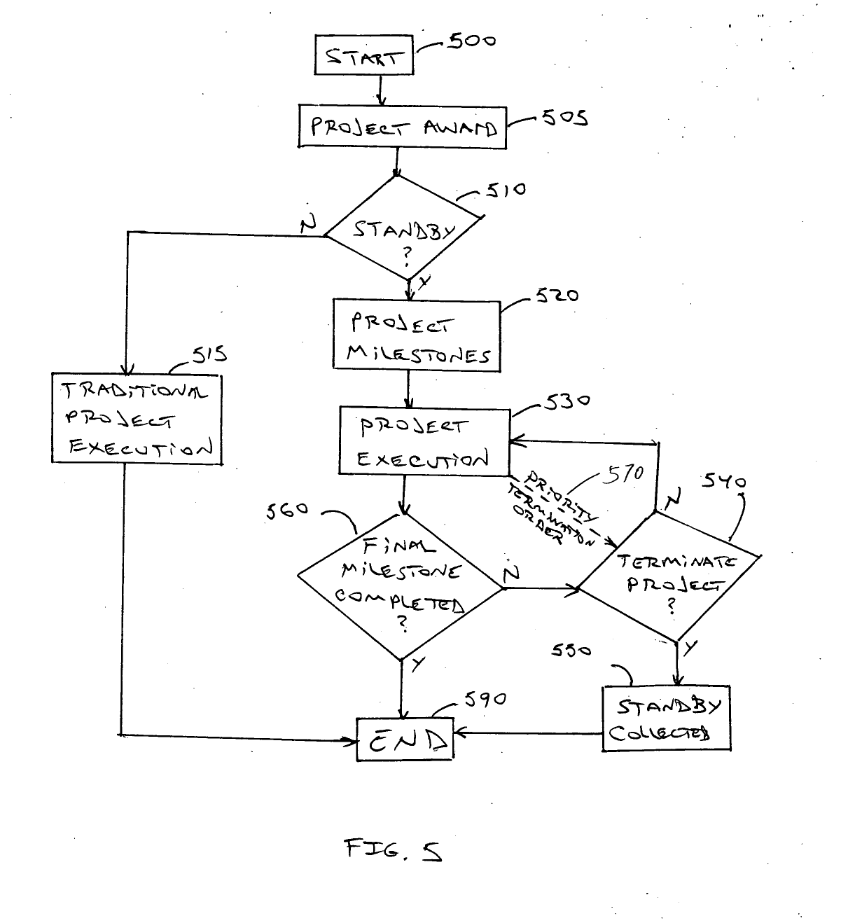

FIG. 5 illustrates a flow diagram of a project management structure that implements a Standby. Following Start 500, a Project Award 505 is provided. The Project Award 505 can come from any source, but often is the result of a competitive process or direct assignment. Following Project Award 505, or concurrently therewith, a Standby Offer 510 is presented to eligible parties. Should the Standby Offer 510 be declined, flow passes to Traditional Project Execution 515 and the project is managed and performed in a traditional manner. When the Standby Offer 510 is accepted, Project Milestones 520 that are indexed to expiration of the Standby are provided. Project Milestones 520 may be provided along with the award of the Standby, or they may be provided prior to or following the Standby award. Further, Project Milestones 520 may be the result of negotiations or they may be directed. Project Milestones 520 may be indexed to the Standby based on expenditure of project funds,performance of project tasks, the elapse of time, or any combination of the above. For example, when project milestones are indexed to the Standby based on project funds, the Standby payoff will decrease in relation to utilization of project finds. Similarly, when project milestones are indexed to the Standby based on elapse of time, the Standby payoff will decrease as time elapses.

Following provision of Standby Offer 510 and Project Milestones 520, the project is Executed 530 in accordance with the milestones. As each milestone is arrived at, a test for Project Termination 540 is conducted. If the project is no longer feasible, then Project Termination 540 will indicate that the project should be terminated and the remaining Standby Collected 550, after which the project will wrap-up and the process Ends 590. The project can cease to be feasible for any reason, but usually it is because the project lacks economic viability. If the project is not to be terminated, then testing for completion of the final milestone is conducted 560. If the last milestone is completed, the project is finished and the process Ends 590. If the last milestone is not completed, then the process returns to Project Execution 530 for continuation of the project until the next milestone is reached and the test for Project Termination 540 is conducted again. It should be noted that Project Milestones 520 are not the only break points at which the Project Termination 540 decision is available. At any point during Project Execution 530 a Priority Termination Order 570 can be issued that will immediately transfer control of the process to the Project Termination query 540. The Priority Termination Order 570 can arise because an unforeseen occurrence renders continuation of the project infeasible. Such an occurrence could be a sudden change in production costs, loss of key resource(s), a change in regulatory conditions, etc. Priority Termination Order 570 is a feature that enables termination of the project at any point in the process, including between milestone checkpoints.

The description of the process illustrated in FIG. 5 has been presented in terms of executing a project. Use of a Standby, however, is not limited to the environment of a project because it is applicable to any investment structure. In particular, the Standby is useful as tool to reward individuals or entities responsible for managing an investment by providing compensation for early termination of an investment that is on a loosing course. The exercise of the Standby can be based on a triggering value that is indicative of the loosing nature of the investment. The triggering value can be based on any measure of investment value, such as magnitude of investment value, the rate of change of investment value, and the acceleration of change of investment value. The acceleration of change of investment value is defined as the rate of change of the rate of change of investment value. The Standby would thus serve as a commission or reward to responsible individuals for minimizing investment losses. Because the lifecycle of an investment may differ from that of a project, the duration of an investment Standby can be open-ended, or renewable if initially set to expire.

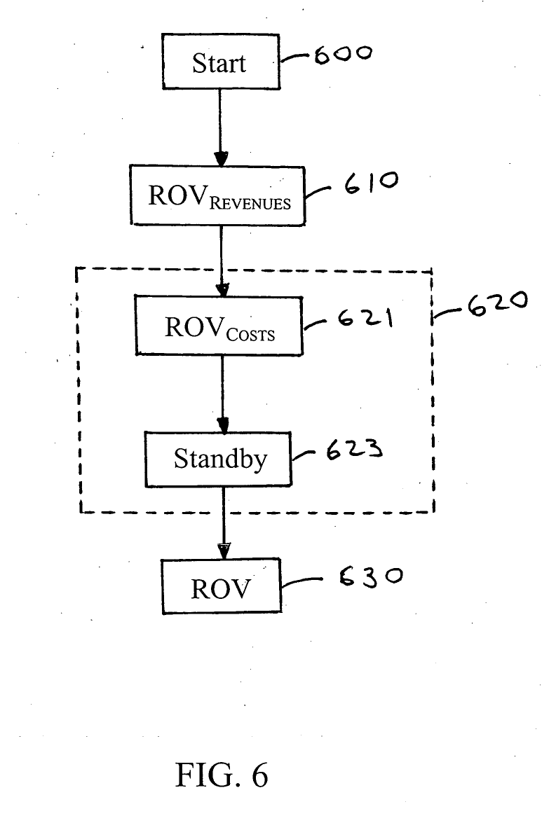

FIG. 6 illustrates a flow diagram where a real options valuation of an investment is formed using a Standby. Following Start 600, the real options value of the forecasted revenues of the investment, ROV_{REVENUES} 610, is provided. ROV_{REVENUES} 610 can be determined using any valuation methodology useful in figuring the value of real options. Such methodologies include, but are not limited to, decision tree analysis, binomial method, and the Black-Scholes method. ROV_{REVENUES} 610 can be determined by the individual or entity conducting the investment valuation or it may be supplied, as might occur when another entity or source is consulted.

Another step is to provide the real options value of the forecasted costs of the investment, ROV_{COSTS} 621. Forecasted costs include, but are not limited to, development costs, cost of goods sold, fixed and variable costs relating to the investment under consideration, etc. ROV_{COSTS} 621 can be determined using any valuation methodology useful in figuring the value of real options. Such methodologies include, but are not limited to, decision tree analysis, binomial method, and the Black-Scholes method. ROV_{COSTS} 621 can be determined by the individual or entity conducting the investment valuation or it may be supplied, as might occur when another entity or source is consulted.

Another step is to provide a Standby 623 for the investment. The Standby 623 can be provided by the individual or entity sponsoring the investment or it may be supplied, as might occur when another entity or source is consulted. The Standby 623 could be provided by the individual or entity managing the investment. Because Standby 623 influences the cost structure of an investment, it can be combined with ROV_{COSTS} 621 to form Net ROV_{COSTS} 620. Net ROV_{COSTS} 620 can be combined with ROV_{REVENUES} 610 to form real options value (ROV) 630 for the investment.

It is contemplated that the foregoing steps will be performed in a sequence resembling that described but this is not essential to form the total real options value (ROV) 630 for the investment. Thus, Net ROV_{COSTS} 620 may be provided before ROV_{REVENUES} 610 and vice versa. ROV 630, then, is formed by combining Net ROV_{COSTS} 620 with ROV_{REVENUES} 610 regardless of the order in which they were obtained. Further, ROV_{COSTS} 621 and Standby 623 need not be combined to form Net ROV_{COSTS} 620 in a separate step, but may each be combined individually with ROV_{REVENUES} 610. Note that if ROV_{COSTS} 621 and Standby 623 are to combine separately with ROV_{REVENUES} 610 in forming ROV 630, the negative operator will carry through Equation 3 so that ROV_{COSTS} 621 will reduce ROV 630 and Standby 623 will increase ROV 630.

Standby 623 may be provided at any time during the process illustrated in FIG. 6. In absence of Standby 623, the process illustrated in FIG. 6 reduces to the process illustrated in FIG. 2 until such a time as Standby 623 is provided. ROV_{REVENUES} 610, ROV_{COSTS} 621 and Standby 623 may be determined via computer using software configured to evaluate real options and Standby.

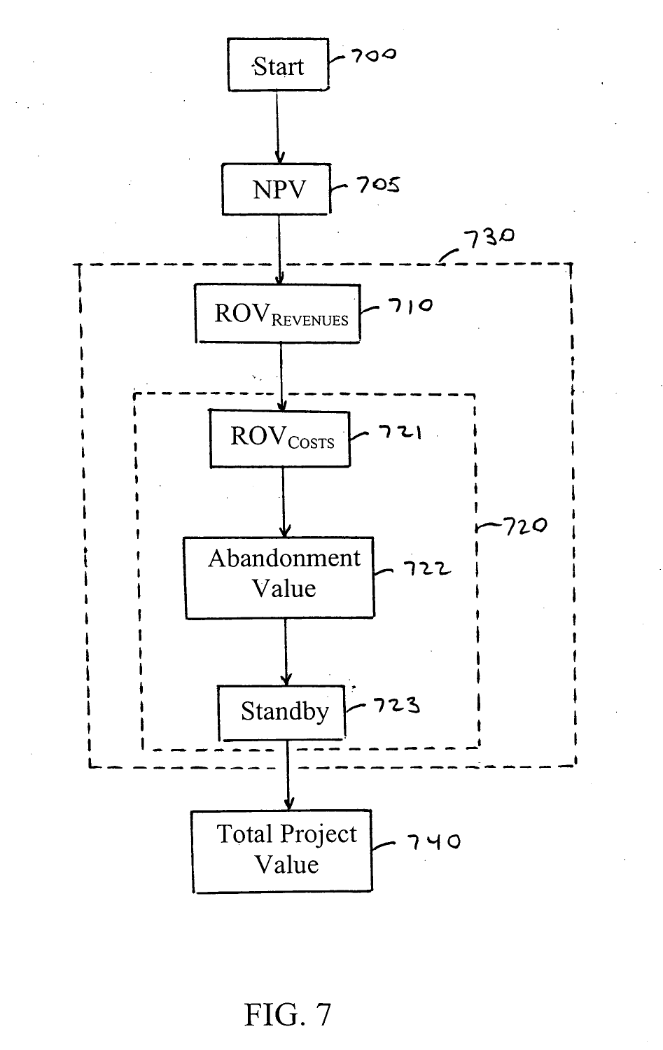

FIG. 7 illustrates a flow diagram where total project value is formed using both Abandonment Value and a Standby. Following Start 700, values for NPV 705 and ROV_{REVENUES} 710 are provided. NPV 705 and ROV_{REVENUES} 710 are provided for in the same manner as the steps of providing NPV 405 and ROV_{REVENUES} 410 in FIG. 4, respectively. ROV_{COSTS}, however, is comprised of three sub-components: ROV_{COSTS} 721, Abandonment Value 722 and Standby 723. Thus, the total real options value of costs is a net value and can be identified as Net ROV_{COSTS} 720.

The step of providing ROV_{COSTS} 721 is provided for in the same manner as the step of providing ROV_{COSTS} 421 in FIG. 4. In another step, Abandonment Value 722 is provided. The step of providing Abandonment Value 722 is provided for in the same manner as the step of providing Abandonment Value 422 in FIG. 4. In another step, Standby 723 is provided. The step of providing Standby 723 is provided for in the same manner as the step of providing Standby 623 in FIG. 6. Standby 723 is combined with Abandonment Value 722 and ROV_{COSTS} 721 to form Net ROV_{COSTS} 720. Net ROV_{COSTS} 720 is combined with ROV_{REVENUES} 710 to form Net Option Value (NOV) 730. NOV 730 is combined with NPV 705 to form Total Project Value 740.

It is contemplated that the foregoing steps will be performed in a sequence resembling that described but this is not essential to arriving at Total Project Value 740. Thus, Net ROV_{COSTS} 720 may be provided before ROV_{REVENUES} 710 and vice versa. NOV 730, then, is formed by combining Net ROV_{COSTS} 720 with ROV_{REVENUES} 710 regardless of the order in which they were obtained. Further, ROV_{COSTS} 721, Abandonment Value 722 and Standby 723 need not be combined to form Net ROV_{COSTS} 720 in a separate step, but may each be combined individually with ROV_{REVENUES} 710. Additionally, ROV_{COSTS} 721, Abandonment Value 722 and Standby 723 need not be combined with ROV_{REVENUES} 710 in a separate step to form NOV 730, but may be combined individually with NPV 705 to form Total Project Value 740. Note that if ROV_{COSTS} 721, Abandonment Value 722 and Standby 723 are to combine separately in forming Total Project Value 740, the negative operator will carry through Equation 4 so that ROV_{COSTS} 721 will reduce Total Project Value 740 and Abandonment Value 722 and Standby 723 will increase Total Project Value 740.

Abandonment Value 722 and Standby 723 may be provided at any time during the process illustrated in FIG. 7. In absence of Abandonment Value 722 and Standby 723, the process illustrated in FIG. 7 reduces to the process illustrated in FIG. 3 until such a time as Abandonment Value 722 and Standby 723 are provided. Abandonment Value 722 and Standby 723 need not be provided at the same time. NPV 705, ROV_{REVENUES} 710, ROV_{COSTS} 721, Abandonment Value 722 and Standby 723 may be determined via computer using software configured to evaluate real options and net present value.

### The Standby In The Public Sector

Another embodiment of the invention is directed to incorporation of a public sector Standby within the cost option assessment. The concept of option based thinking in general, and the Standby in particular, are applicable to the public sector. For instance, the Standby could be used by government agencies and foundations to leverage grant programs that fund research. Grants are often used to stimulate basic research that is of potential value to society but considered too risky to be undertaken by the private sector. But some research does result in profitable new products, such as pharmaceuticals and electronics, which opens the door to critics who contend that such research should have been paid for by the private sector. Thus, grant programs restore funding to non-commercial research by selling a Standby to grant seekers.

The public sector Standby can serve as a way to pay for non-commercial research by functioning as failure insurance. Universities and private companies can fund risky research themselves, but purchase a Standby from the agency providing the grant. If the research results in commercialization, then government would not have funded commercially viable research. On the other hand, if the research does not result in commercialization, then the university or company can exercise the Standby and put the non-commercial research back to the agency and receive the value of the Standby to reimburse itself for the research. The Standby serves two purposes: first, the Standby provides incentive so that government funds only truly risky research and not research that arguably should have been funded by the private sector. Second, the Standby allows government to stimulate more research with the same amount of money because it limits funding to non-commercial research, with funding of commercial research being absorbed by the private sector. Further, the premiums that the government collects from the sale of Standbys would provide further dollars to stimulate research in other areas.

The process comprising the steps performed in accordance with FIGS. 2-5 may be implemented in software and as such operable on any viable computing platform. Further, a software implemented design may be object oriented wherein elements of the design are represented by software components, which in turn can be data structures. Such data structures could be objects in an object-oriented environment. Further, such data structures could be embedded within the software implementation of the design. As used herein, data structure is to be broadly construed and includes such software constructs as databases.

Numerous characteristics and advantages have been set forth in the foregoing description, together with details of structure and function. The novel features are pointed out in the appended claims. This disclosure, however, is illustrative only and changes may be made in detail within the principle of the invention to the full extent indicated by the broad general meaning of the terms in which the appended claims are expressed.

1. A method for determining a real option value, the method comprising:
providing a first option value of forecasted revenues associated with said real option;
providing a second option value of forecasted costs associated with said real option; and
reducing said first option value by said second option value to determine said real option value.

2. The method for determining the real option value of claim 1, wherein costs include development costs, cost of goods sold, fixed and variable costs relating to the investment under consideration.

3. The method for determining the real option value of claim 1, wherein said forecasted costs include adjustment for abandonment value.

4. The method for determining the real option value of claim 1, wherein said forecasted costs include adjustment for standby.

5. The method for determining the real option value of claim 4, wherein said standby is a public sector standby.

6. A method of determining total project value of an investment, the method comprising:
determining data representative of net present value;
determining data representative of real option value of forecasted revenues of the investment;
determining data representative of real option value of the forecasted costs of the investment;
combining said data representative of real option value of forecasted revenues with said data representative of real option value of forecasted costs to determine net option value; and
combining said net present value with said net option value to determine said total project value.

7. The method of determining total project value of claim 6, wherein costs include development costs, cost of goods sold, fixed and variable costs relating to the investment.

8. At least one computer-readable medium having a plurality of computer executable instructions for facilitating determination of total project value, the computer executable instructions comprising steps of:
determining data representative of net present value;
determining data representative of real option value of forecasted revenues of the investment;
determining data representative of real option value of the forecasted costs of the investment; and
determining a value for total project value by adding data representative of real option value of forecasted revenues to said data representative of net present value and subtracting data representative of real option value of the forecasted costs.

9. The method of forming total project value of claim 6, wherein said forecasted costs include adjustment for abandonment value.

10. The method of forming total project value of claim 6, wherein said forecasted costs include adjustment for standby.

11. The computer-readable medium of claim 8, wherein the computer executable instructions determining data representative of real option value of the forecasted costs include adjustment for abandonment value.

12. The computer-readable medium of claim 8, wherein the computer executable instructions determining data representative of real option value of the forecasted costs include adjustment for standby.

13. The method of forming total project value of claim 10, wherein said standby is a public sector standby.

14. The computer-readable medium of claim 12, wherein said standby is a public sector standby.

15. A method of controlling the duration of an investment, the method comprising:
providing a standby having the capacity to expire; and
providing a trigger value capable of serving as a basis for exercising said standby; and
exercising or not exercising said standby based on said trigger value.
